(19) United States
(12) Patent Application Publication
(10) Pub. No.: US 2007/0181055 A1
(43) Pub. Date: Aug. 9, 2007

(54) Meter device

(76) Inventor: Ming-Tsung Chou, Taipei (TW)

Correspondence Address: TROXELL LAW OFFICE PLLC;SUITE 1404, 5205 LEESBURG PIKE, FALLS CHURCH, VA, 22041, US

(21) Appl. No.: 11/346,336

(22) Filed: Feb. 3, 2006

(51) Int. Cl. G01D 11/28

(52) U.S. Cl. 116/286

(57) ABSTRACT

A meter device in which an indicating needle set can get an range of rotation of nearly 360 degrees. The device comprises a light guiding plate, an indicating needle set, a light source, a driver and a control circuit; wherein the light guiding plate has a hole, the light source corresponds with the light guiding plate in order that the light source can project light beams to the light guiding plate; the driver has a rotor, and the indicating needle set is extended through the hole to be provided on the rotor; the control circuit is connected electrically with the driver in order that the rotor of the driver is rotated, and the rotor can do rotating of nearly 360 degrees by control of the control circuit. The device is suitable for various meters such as a pressure meter, a water temperature meter, a rotating rate meter, an oil meter, a speed meter etc.

### BACKGROUND OF THE INVENTION

1. Field of the Invention

The present invention relates to a meter device, and more particularly to a meter device in which an indicating needle set can get a range of rotation of nearly 360 degrees. The device is suitable for various meters such as an engine oil pressure meter, an engine oil temperature meter, a voltage meter, a turbo pressurized meter, a water temperature meter, a rotating rate meter, an oil meter, a gas exhausting temperature meter, a speed meter etc.

2. Description of the Prior Art

In many occasions, panels on meters are widely used as instruments for metering, a user or an operator can do comparison and analysis on the change on a panel of a meter generated by adding new parameters thereto, and then can take an action or make a conclusion.

Referring to FIGS. 1A and 1B which are schematic views of a conventional panel of a meter. In general, the panel of the meter is segmented about 90 to 270 degrees due to the limited rotation of the needle. And because of the fact that a needle is unable to rotate for a further larger range, the area under the needle normally is with scales.

The present invention provides a novel meter device to improve the deficiency of the conventional meter technique.

### SUMMARY OF THE INVENTION

The primary objective of the present invention is to provide a meter device, wherein an indicating needle set can be rotated for a further larger range.

In order to achieve the above objective, the meter device provided by the present invention comprises a light guiding plate, an indicating needle set, a driver and a control circuit; wherein the light guiding plate has a hole, the driver has a rotor, and the indicating needle set is extended through the hole and provided thereon the rotor. The control circuit is electrically connected with the driver in order that the rotor of the driver is rotated, and can do rotating of nearly 360 degrees by control of the control circuit.

One feature of the present invention is that, the meter device further comprises a light source which correspond with the light guiding plate in order that the light source can project light beams to the light guiding plate.

The present invention will be apparent in its content and effect to be achieved after reading the detailed description of the preferred embodiment thereof in reference to the accompanying drawings.

### BRIEF DESCRIPTION OF THE DRAWINGS

FIGS. 1A and 1B are schematic views of a conventional panel of a meter showing the degrees of rotating of an indicating needle set;

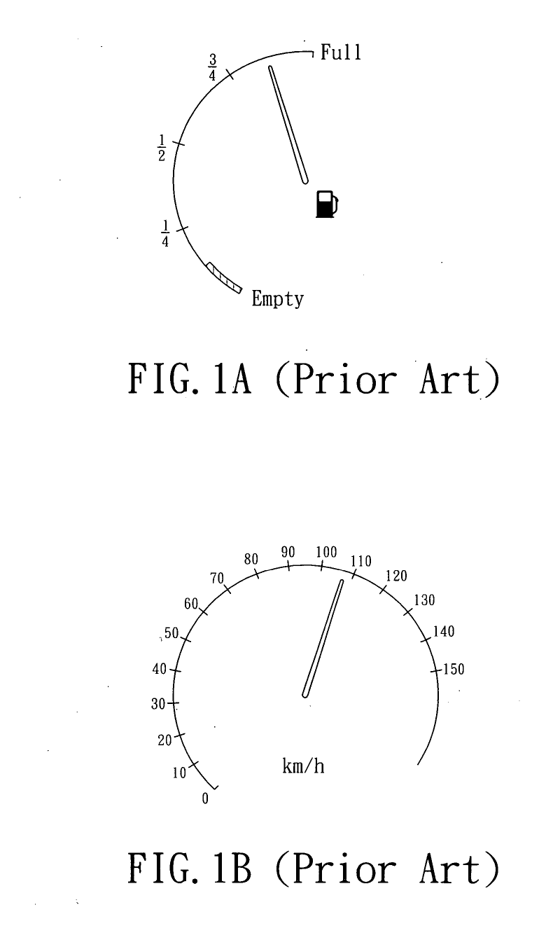

FIG. 2 is an exploded perspective view showing the elements in an embodiment of a meter device of the present invention;

FIGS. 3A and 3B are perspective views showing the embodiment of the meter device of the present invention after assembling.

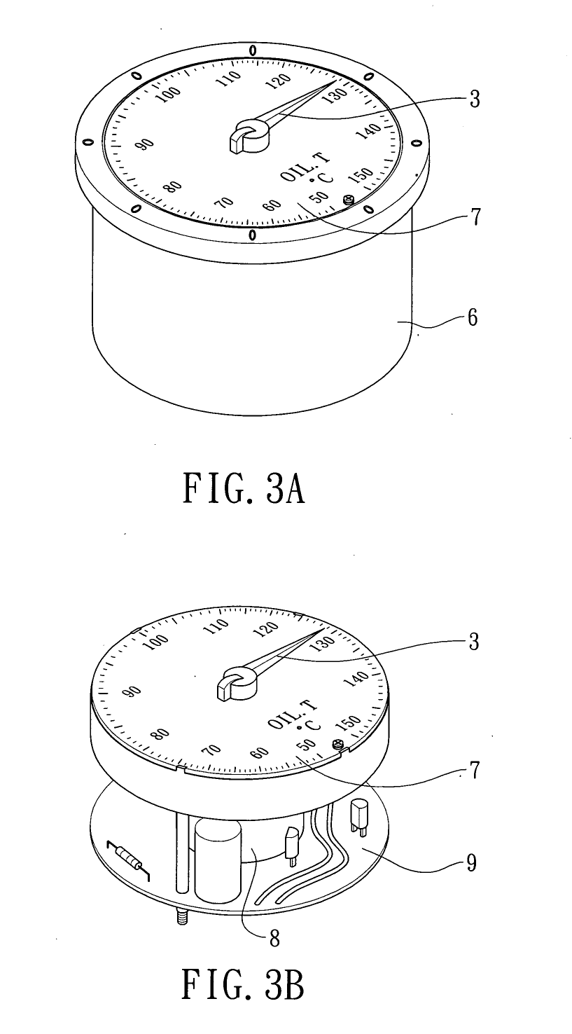

### DETAILED DESCRIPTION OF THE PREFERRED EMBODIMENT

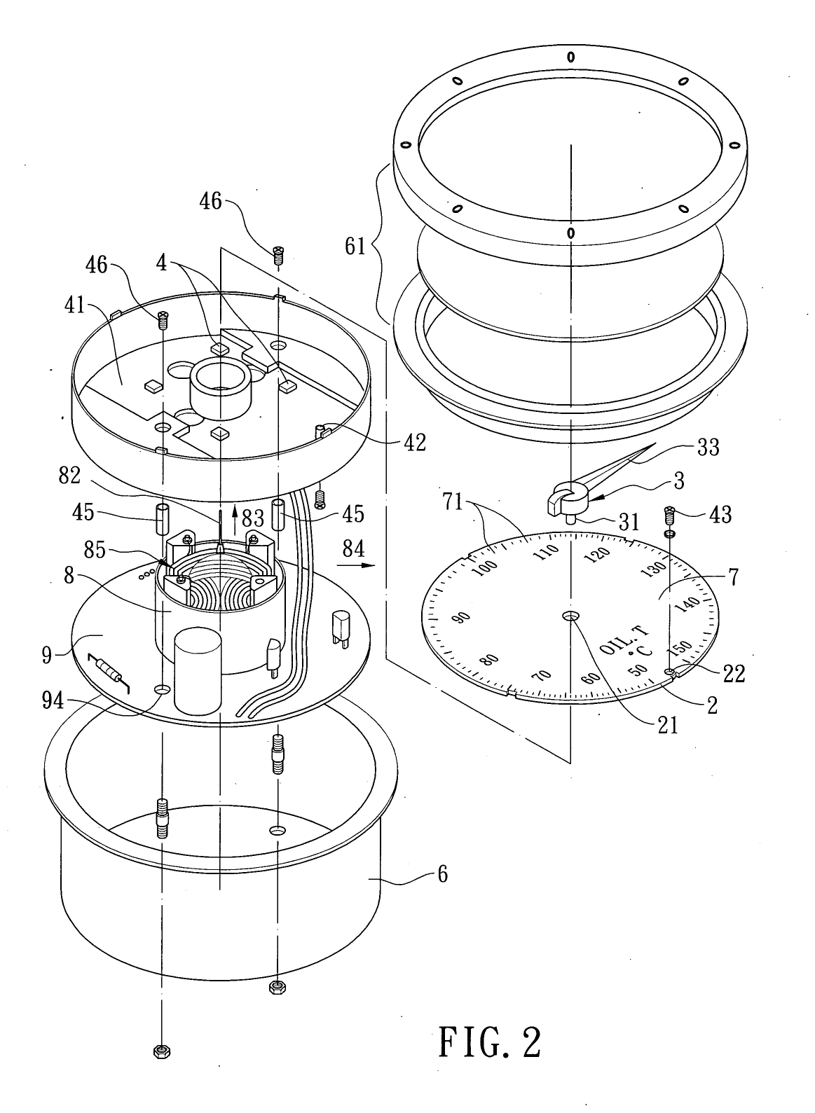

Referring to FIG. 2 showing an embodiment of a meter device of the present invention, the meter device comprises a light guiding plate 2, an indicating needle set 3, a driver 8 and a control circuit 9.

The light guiding plate 2 has a hole 21 that extends through the light guiding plate 2. The indicating needle set 3 has a rigid light pipe 31 and a needle 33; the rigid light pipe 31 is extended through the hole 21 to connect with the driver 8.

The meter device of the present invention further has a display panel 7, the display panel 7 clings to the light guiding plate 2, so that the display panel 7 can show the light beams transmitted by the light guiding plate 2. The display panel 7 is preferably provided between the light guiding plate 2 and the indicating needle set 3. The display panel 7 is normally round and is made of transparent material, and it is segmented into a plurality of indicating areas 71 according to the natures to be measured such as pressure, speed or temperature etc. The user can obtain information based on the location of the needle 33 on the indicating areas 71.

A light source 4 is provided on a base plate 41 to correspond with the light guiding plate 2 in order that the light source 4 can project light beams to the light guiding plate 2, the rigid light pipe 31 and the needle 33. In the preferred embodiment of the present invention, the light source 4 is a light emitting diode (LED).

The driver 8 is provided on the control circuit 9 and includes a coil 85 and a rotor 82 covered with the coil 85. The indicating needle set 3 is extended through the hole 21 to be provided on the rotor 82. The coil 85 preferably covers the rotor 82 along a first direction 83 and a second direction 84, the first direction 83 and the second direction 84 are perpendicular to each other. The control circuit 9 has a micro-processor (or an IC, neither of them is shown), the control circuit 9 can control rotating angle of the rotor 82, so that the rotor 82 can do rotating of nearly 360 degrees.

The light guiding plate 2 of the present invention further has at least a hole 22; the base plate 41 is provided correspondingly with a post 42 for extending through the hole 22, thereby when a screw 43 is extended through both of them, the light guiding plate 2 can be fixed on the base plate 41. The base plate 41 is further provided with a pair of posts 45 for extending through holes 94 correspondingly provided on the control circuit 9, thereby the base plate 41 can be fixed on the control circuit 9 with two screws 46. Lastly, a housing 6 (including an upper housing 61) is used to envelop the control circuit 9, the driver 8, the light source 4 and the light guiding plate 2; and a plurality of wires (not shown) can be extended from the control circuit 9 to extend through the housing 6, in this way, the present invention can be applied to a vehicle.

By the fact that the indicating needle set 3 of the present invention can do rotating of nearly 360 degrees, the display panel 7 can be segmented into more indicating areas 71 taking advantage of the area under the needle.

In conclusion, according to the description and the drawings disclosed above, the present invention can surely achieve the expected objective thereof to provide a meter device that can do rotating of nearly 360 degrees.

The embodiment stated above is only for illustrating the technical measures of the present invention, it will be apparent to those skilled in this art that various equivalent modifications or changes according to what is disclosed and taught of and without departing from the spirit of this invention shall also fall within the scope of the appended claims.

1. A meter device comprising:
a light guiding plate having a hole;
an indicating needle set;
a driver having a rotor, said indicating needle set is extended through said hole to be provided on said rotor; and
a control circuit connected electrically with said driver in order that said rotor of said driver is rotated, and said rotor is adapted to rotating of nearly 360 degrees by control of said control circuit.

2. The meter device as in claim 1, wherein said indicating needle set has a rigid light pipe and a needle.

3. The meter device as in claim 1, wherein said meter device further comprises a light source which corresponds with said light guiding plate in order that said light source projects light beams to said light guiding plate.

4. The meter device as in claim 3, wherein said light source is a light emitting diode.

5. The meter device as in claim 1, wherein said light guiding plate has a display panel to be segmented into a plurality of areas.
